(19) United States
(12) Patent Application Publication
(10) Pub. No.: US 2009/0066500 A1
(43) Pub. Date: Mar. 12, 2009

(54) CALLING-HELP WARNING DEVICE OF A THIRD BRAKE LIGHT OF AN AUTOMOBILE

(76) Inventor: Pin-Ying YU, Tainan City (TW)

Correspondence Address: Pin-Ying YU, P. O. BOX 90, Tainan City, 70499, TW

(21) Appl. No.: 11/852,305

(22) Filed: Sep. 9, 2007

(51) Int. Cl. B60Q 1/44

(52) U.S. Cl. 340/479

(57) ABSTRACT

A calling-help warning device of a third brake light of an automobile includes a remote controller and a calling-help warning device. The remote controller has at least one battery, a switch, a plurality of control buttons and a wireless signal emitter that are sequentially linked up. The calling-help warning device is provided with a wireless signal receiver, a control unit, at least one inductor, a third brake light, a setting switch, a plurality of brake lights, and a power supply. If a car is parked, a driver can utilize the remote controller to activate the calling-help warning device. If the car is intruded by a thief, the at least one inductor can activate the third brake light to keep on flashing to warn people thereabout for help.

### BACKGROUND OF THE INVENTION

1. Field of the Invention

This invention relates to a calling-help warning device of a third brake light of an automobile, particular to one enabling the third brake light to keep on flashing to warn people thereabout that the car is broken in illegally, asking for help.

2. Description of the Prior Art

Commonly, an automobile anti-burglar device is used as a warning means for protecting a car from stolen. It is based on the pressure detected in a car, supersonic induction, the vibrating induction posed by improper touching or shock, or induction of illegally opening a door to warn or send an owner a message that the car is being intruded. But, due to some reasons such as that the warning sound is too low to frighten the thief, the owner is too far away to get the message, or the owner can not reach the car in time, so the car cannot be effectively prevented from being robbed.

### SUMMARY OF THE INVENTION

The objective of this invention is to offer a calling-help warning device activated by a remote controller. With an inductor in the calling-help warning device, as soon as a car is intruded by a burglar, a third brake light can be lit up to keep on flashing to warn people thereabout for help.

The main feature of the invention is to provide a calling-help warning device including: a wireless signal receiver, a control unit, at least one inductor, a third brake light, a setting switch, a plurality of brake lights, and a power supply. The wireless signal receiver is employed for receiving signals sent from a remote controller. The control unit is connected with the wireless signal receiver for enabling a car to be induced and give a warning. The at least one inductor is connected with the control unit to detect intrusion or touching with the car. The third brake light is connected with the at least one inductor for warning cars traveling behind it or calling for help to warn the burglar. The setting switch is connected with the third brake light to turn on/off the third brake light. The plurality of brake lights are connected with the third brake light for warning cars traveling behind it. And, the power supply is respectively connected with the control unit, the at least one inductor, the setting switch and the plurality of brake lights to supply power.

### BRIEF DESCRIPTION OF DRAWINGS

This invention is better understood by referring to the accompanying drawings, wherein:

FIG. 1 is a circuit block diagram of a calling-help warning device of a third brake light of an automobile in the present invention;

FIG. 2 is a schematic view of the calling-help warning device of a third brake light of an automobile in the present invention being in use; and,

FIG. 3 is another schematic view of the calling-help warning device of a third brake light of an automobile in the present invention being in use.

### DETAILED DESCRIPTION OF THE PREFERRED EMBODIMENT

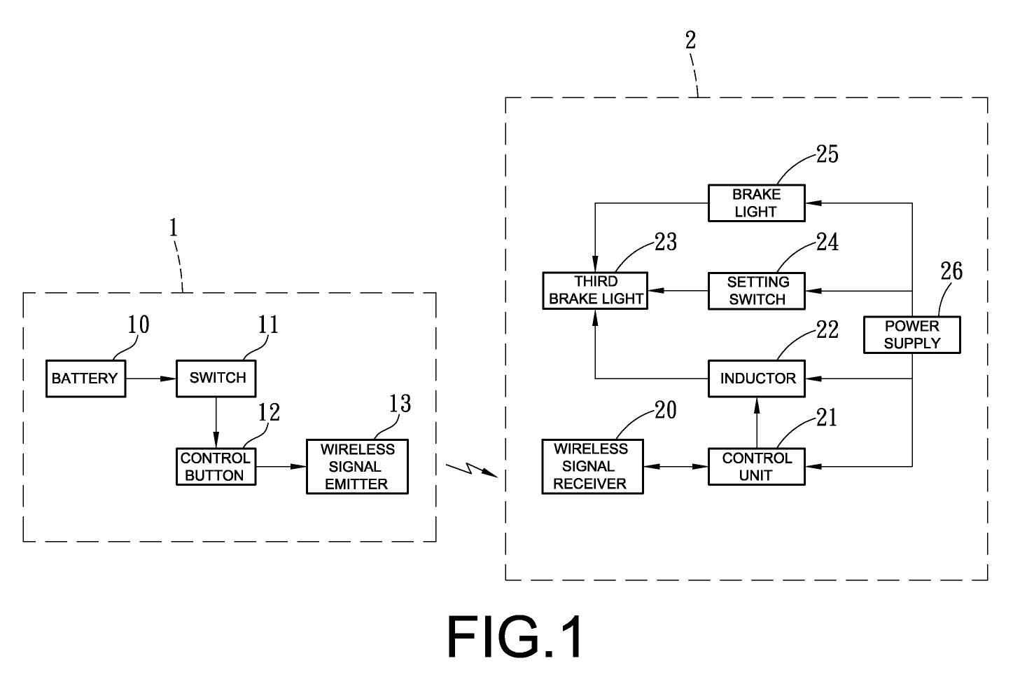

As shown in FIG. 1, a preferred embodiment of a calling-help warning device of a third brake light of an automobile in the present invention is composed of a remote controller 1 and a calling-help warning device 2.

The remote controller 1 is provided with at least one battery 10, a switch 11, a plurality of control button 12 and a wireless signal emitter 13, which are sequentially linked up.

The calling-help warning device 2 is provided with a wireless signal receiver 20 employed for receiving signals sent from the remote controller 1, a control unit 21 connected with the wireless signal receiver 20 for enabling the car to be induced and give a warning, at least one inductor 22 connected with the control unit 21 to detect intrusion or touching with a car, a third brake light 23 connected with the at least one inductor 22 for warning cars traveling behind it or calling for help to warn a burglar, a setting switch 24 connected with the third brake light 23 to turn on/off the third brake light 23, a plurality of brake lights 25 connected with the third brake light 23 for warning cars traveling behind it, and a power supply 26 respectively connected with the control unit 21, the at least one inductor 22, the setting switch 23 and the plurality of brake lights 25 to supply power.

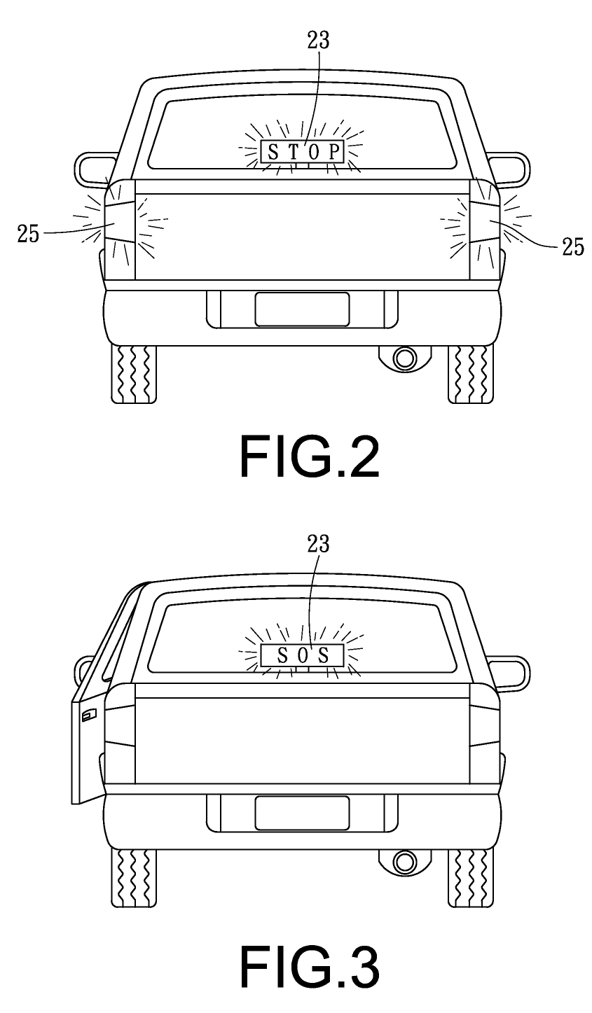

In using, as soon as a driver steps on the brake while traveling, the plurality of brake lights 25 and the third brake light 23 are lit up simultaneously. By the time, the third brake light 23 can be designed to display with characters, such as “STOP”, as shown in FIG. 2. If the car is parked, a driver has just to turn on the switch 11 of the remote controller 1 and then, press the plurality of control button 12 to enable the wireless signal emitter 13 to send signals to the wireless signal receiver 20 that is to simultaneously control the control unit 21 to activate the at least one inductor 22. Therefore, if the car is intruded by a thief, the at least one inductor 22 can sense it and activate the third brake light 23 to keep on flashing. By the time, the third brake light 23 can be designed to display with characters such as “SOS”, as shown in FIG. 3, to inform people thereabout for help.

While the preferred embodiment of the invention has been described above, it will be recognized and understood that various modifications may be made therein and the appended claims are intended to cover all such modifications that may fall within the spirit and scope of the invention.

What is claimed is:

1. A calling-help warning device of a third brake light of an automobile, said device comprising:
a remote controller composed of at least one battery, a switch, a plurality of control buttons and a wireless signal emitter that are sequentially linked up;
a calling-help warning device activated by signals sent from said remote control; and,
characterized by said calling-help warning device comprising:
a wireless signal receiver utilized to receive signals transmitted from said remote control;
a control unit connected with said wireless signal receiver for enabling a car to be inducible and warning;
at least one inductor connected with said control unit to detect intrusion or touching with a car;
a third brake light connected with said at least one inductor for warning cars traveling behind it or calling for help to warn the burglar;
a setting switch connected with said third brake light to turn on/off said third brake light;
a plurality of brake lights connected with said third brake light for warning cars traveling behind it; and
a power supply respectively connected with said control unit, said at least one inducer, said setting switch and said plurality of brake lights to supply power.
